(19) United States
(12) Patent Application Publication
(10) Pub. No.: US 2026/0109840 A1
(43) Pub. Date: Apr. 23, 2026

(54) SOLID POLYELECTROLYTE COMPLEX-BASED PLASTICS FROM MODIFIED BIOPOLYMERS

(71) Applicant: THE UNIVERSITY OF CHICAGO, Chicago, IL (US)

(72) Inventors: Matthew Tirrell, Chicago, IL (US); Pamela Cai, Chicago, IL (US)

(21) Appl. No.: 19/271,201

(22) Filed: Jul. 16, 2025

Related U.S. Application Data
(60) Provisional application No. 63/673,328, filed on Jul. 19, 2024.

(51) Int. Cl. C08L 5/08; C08J 11/10; C08J 11/16; C08L 5/04

(52) U.S. Cl. CPC C08L 5/08; C08J 11/105; C08J 11/16; C08L 5/04; C08J 2305/04; C08J 2305/08

(57) ABSTRACT

A plastic material is provided that comprises a solid polyelectrolyte complex formed between modified alginate comprising ionic groups other than carboxylate groups and a biopolymer comprising oppositely charged ionic groups. Methods of forming, recycling, and decomposing the plastic material are also provided.

### CROSS-REFERENCE TO RELATED APPLICATION

The present application claims the priority benefit to U.S. Provisional Patent Application No. 63/673,328 filed on Jul. 19, 2024, the entire disclosure of which is incorporated by reference herein.

### BACKGROUND

Plastic pollution has become an urgent global environmental crisis, with projections of 12 billion tons of plastic waste in landfills or the environment by 2050. Of the more than 400 million tons of plastic produced annually, packaging materials are the largest contributor at approximately 40% due to the growth of single-use plastics and make up 47% of plastic waste because they are recycled at the lowest rate. Single-use is particularly wasteful for materials that have been found to possess lifetimes of tens to hundreds of years. While chemical recycling to monomers and upcycling efforts of plastics aim to keep these materials out of landfills for longer, these methods still face drawbacks including complex separation processes, harsh chemicals, and expensive catalysts. Moreover, lack of alternatives will maintain our reliance on fossil fuels, from which the vast majority of monomers are derived.

### SUMMARY

A biodegradable, recyclable plastic material comprising a solid polyelectrolyte complex formed between modified alginate comprising ionic groups and a biopolymer comprising oppositely charged ionic groups is provided. The present disclosure is illustrated by reference to an Example, below, which describes the synthesis and characterization of a plastic material composed of a solid polyelectrolyte complex formed between modified alginate having sulfonate groups and quaternized chitosan having quaternary ammonium groups. The plastic material maintains stiffness comparable to thin commercial plastics even after six recycling cycles, yielding on average 98% of its mass post-recycling. Its natural biodegradability and salt-controlled recyclability support material circularity, offering a promising alternative to synthetic single-use plastic packaging.

A plastic material is provided that comprises a solid polyelectrolyte complex formed between modified alginate comprising ionic groups other than carboxylate groups and a biopolymer comprising oppositely charged ionic groups. Methods of forming, recycling, and decomposing the plastic material are also provided.

Other principal features and advantages of the disclosure will become apparent to those skilled in the art upon review of the following drawings, the detailed description, and the appended claims.

### BRIEF DESCRIPTION OF THE DRAWINGS

Illustrative embodiments of the disclosure will hereafter be described with reference to the accompanying drawings.

FIGS. 1A-1D illustrate the synthesis of an illustrative biopolymer-based polyelectrolyte complex (PEC). (FIG. 1A) Alginate undergoes chemical modification to alginate-sulfonic acid via NHS-EDC carbodiimide chemistry. (FIG. 1B) Chitosan undergoes chemical modification to quaternized chitosan. (FIG. 1C) Combining alginate and chitosan together leads to liquid-liquid phase separation, where the polymer-rich phase dries into a brittle, tissue-like material. (FIG. 1D) By contrast, combining alginate-sulfonic acid and quaternized chitosan leads to solid-liquid phase separation, where the solid PEC phase can be pressed into a transparent, glassy film. It is this solid PEC phase that is used to provide the present materials.

FIGS. 2A-2D illustrate formation and recycling of biopolymer-based PECs. (FIG. 2A) The illustrative PEC material is first separated from the liquid supernatant before being hot pressed at a temperature of 50° C. and approximately 9 psi. The pressed material is dried to achieve a transparent glassy film that can be used for single-use packaging, an image of which is shown in FIG. 2C. (FIG. 2B) The PEC materials can be recycled by first softening them in 0.6 M NaCl solution and then re-triggering the solid material formation by lowering the salt concentration to 0.1 M NaCl. Following a wash with water, the material can be reprocessed again into a new piece of film, an image of which is shown in FIG. 2D. Other experiments were conducted in which pieces of the PEC material were placed in solutions covering a range of NaCl concentrations. The salt resistance of the PEC material was found to be around 0.6 M NaCl, when the PEC completely dissolves into solution with no observation of a bottom, polymer-rich phase.

FIGS. 3A-3C illustrate mechanical, chemical, and thermal analysis of an illustrative biopolymer-based PEC. (FIG. 3A) Composition of the PEC film across six recycles is shown alongside the recycling efficiency after each recycle where the efficiency is defined as the percent of original mass yielded post recycling. (FIG. 3B) Tensile testing at two different speeds of the PEC film. (FIG. 3C) Heating and cooling of the PEC material revealed no thermal transitions in material structure and behavior. Other experiments were conducted including frequency and temperature sweeps of PEC films (including recycled PEC films) using dynamic mechanical analysis.

FIGS. 4A-4E illustrate barrier properties and biodegradation of illustrative biopolymer-based PECs. (FIG. 4A) Water vapor transmission rate (WVTR) was measured for different thicknesses of the PEC film as well as a control of no film and a polylactic acid (PLA)-based film. Error bars show one standard deviation. (FIG. 4B) The absorbance values over 30 minutes after adding alginate lyase to solutions of either alginate or alginate-sulfonic acid. (FIG. 4C) Schematic of the accessibility of biodegradable linkages in the biopolymer-based PEC in solid form with no added salt and when dissolved at high salt concentrations, such as ocean salinity. (FIG. 4D) The absorbance values of alginate and alginate-sulfonic acid solutions without lyase and after 48 hours of incubation with alginate lyase (error bars are one standard deviation). (FIG. 4E) Electrophoresis through a polyacrylamide gel of quaternized chitosan (qCHI) with and without enzymatic treatment shows degradation of qCHI by chitosanase into lower molecular weight polymers. The molecular weights of the ladder polymers on the left are, from top to bottom: 250 kDa, 150 kDa, 100 kDa, 75 kDa, 50 kDa, 37 kDa, 25 kDa, 20 kDa, 15 kDa, 10 kDa.

FIG. 5 is a schematic depiction illustrating formation of an illustrative material composed of a solid PEC formed between modified alginate and modified chitosan, use of the material in packaging applications, and recycling of the material.

### DETAILED DESCRIPTION

The present disclosure provides a biodegradable, recyclable plastic material comprising a solid polyelectrolyte complex formed between modified alginate comprising ionic groups and a biopolymer comprising oppositely charged ionic groups. In the solid polyelectrolyte complex, ionic groups of the modified alginate associate with oppositely charged ionic groups of the biopolymer via electrostatic attraction.

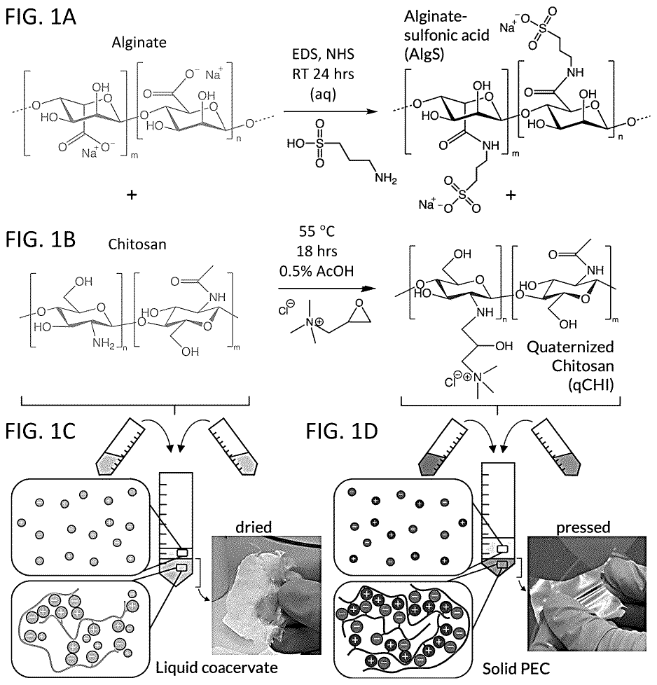

Alginate refers to the salt form of algin, a naturally occurring polysaccharide found in brown algae and some bacteria. An illustrative alginate is sodium alginate which may be represented by the chemical structure shown in the left image of FIG. 1A. This structure shows that the polysaccharide is a linear copolymer composed of β-D-mannuronate (M) and 1-4 linked α-L-guluronate (G) residues. The alginate being used may be characterized by the species of brown algae/bacteria from which it originates as well as the particular process used to extract it. As used herein, the term “alginate” encompasses any type of alginate derived from different species and different extraction processes. Similarly, different salt forms are encompassed, e.g., sodium alginate, calcium alginate, potassium alginate, etc. The alginate being used may also be characterized by its weight average molecular weight (M_{w}), selection of which can depend upon the desired properties and use of the plastic material. Illustrative molecular weights include those in a range of from 10 kDa to 100 kDa. This includes from 15 kDa to 95 kDa and from 15 kDa to 90 kDa. The M_{w} may be determined as described in the Example below.

With reference back to the chemical structure of sodium alginate shown in FIG. 1A, this image shows that alginate is a polyanionic biopolymer comprising carboxylate groups (—CO₂⁻) covalently bound to monosaccharide units of the polysaccharide chain. In the present plastic materials, the alginate that forms the solid polyelectrolyte complex is modified to provide a different type of ionic group, e.g., a different type of anionic group, in the biopolymer. This includes converting the carboxylate groups of alginate to a different type of anionic group. Herein, “unmodified alginate” (or simply, “alginate”) refers to the naturally occurring polysaccharide (regardless of its source and extraction method), while “modified alginate” refers to alginate that has been further processed to include these different ionic groups.

Selection of the different type of ionic group being used in the modified alginate depends upon the desired properties and use for the plastic material. Selection also depends upon which type of biopolymer (further described below) is being used to form the solid polyelectrolyte complex with the modified alginate. However, the different type of ionic group in the modified alginate generally has a relatively high degree of ionization in water over a relatively broad pH range. As noted above, in embodiments, the modified alginate comprises a different type of anionic group (i.e., other than carboxylate groups). An illustrative different type of anionic group is a sulfonate group —SO₃⁻. The “—” represents the linkage to a monosaccharide unit of the polysaccharide chain. The chemical structure of this linkage depends upon the process used to modify the alginate. In embodiments, the linkage comprises an amide group and an alkyl group between the amide group and the sulfonate group. The alkyl group may be a linear alkyl group having various numbers of carbon atoms, e.g., 1, 2, 3, 4, etc. In embodiments, the anionic group may be represented by the formula —C(O)NH(CH₂)ₙSO₃⁻, wherein n may vary as described herein. In this formula, the “—” represents the covalent bond between the carbon atom of the anionic group and a carbon atom of the monosaccharide unit of the polysaccharide chain. In embodiments, the anionic group has the formula —C(O)NH(CH₂)₃SO₃⁻. (See FIG. 1A, right image.) Another illustrative different type of anionic group is a phosphate group —OPO₃⁻. The “—” linkage for phosphate groups may be any of those described above for sulfonate groups.

The Example below describes a method that may be used to modify alginate with sulfonate groups, including the particular sulfonate groups described above. This method involves reacting an amino alkyl sulfonate with alginate using 1-ethyl-3-(3-dimethylaminopropyl) carbodiimide/N-hydroxysuccinimide (EDC/NHS) coupling. This method may be carried out as described in the Example below to provide the modified alginate with a desired degree of substitution. The degree of substitution, which may also be measured as described in the Example, below, is selected depending upon the desired properties and use for the plastic material. In embodiments, the degree of substitution is relatively high, including at least 70%, at least 75%, at least 80%, at least 85%, at least 90%, at least 95%, 100%, or a range between any of these values. It was found that the degree of substitution of the modified alginate is also related to the salt resistance of the solid polyelectrolyte complex, i.e., the salt concentration at which the complex dissolves. For example, a degree of substitution less than 70% led to dissolution of the solid polyelectrolyte at salt concentrations less than desired (e.g., less than 0.6 M NaCl).

The solid polyelectrolyte complex of the present plastic material is formed between the modified alginate described above and another biopolymer comprising oppositely charged ionic groups. A variety of biopolymers (including polysaccharides) may be used, providing the biopolymer is naturally occurring. An illustrative biopolymer is chitosan. Chitosan refers to the deacetylated form of chitin, a naturally occurring polysaccharide found in the exoskeletons of marine invertebrates (e.g., crabs, shrimp shells), cuticles of insects, and certain fungi. Chitin is an N-acetylated polymer of β-(1,4)-D-glucosamine. Chitosan may be represented by the chemical structure shown in the left image of FIG. 1B. The chitosan being used may be characterized by the species of marine invertebrate/insect/fungi from which it originates as well as the particular process used to extract it. As used herein, the term “chitosan” encompasses any type of chitosan derived from different species and different extraction processes. The chitosan being used may also be characterized by its weight average molecular weight (M_{w}), selection of which can depend upon the desired properties and use of the plastic material. Illustrative molecular weights include those in a range of from 15 kDa to 1000 kDa. This includes from 20 kDa to 750 kDa and from 25 kDa to 500 kDa.

With reference back to the chemical structure of chitosan shown in FIG. 1B, this image shows that chitosan comprises primary amine groups (—NH₂) covalently bound to monosaccharide units of the polysaccharide chain. Depending upon pH, these amine groups may be protonated such that chitosan may be considered to be polycationic. In embodiments, unmodified chitosan may be used. Herein, “unmodified chitosan” (or simply, “chitosan”) refers to the naturally occurring polysaccharide (regardless of its source and extraction method). In other embodiments, the chitosan that forms the solid polyelectrolyte complex is modified to provide a different type of ionic group of opposite charge as the ionic groups of the modified alginate. This includes converting the primary amine groups of chitosan to the oppositely charged ionic groups, e.g., cationic groups. Thus, “modified chitosan” refers to chitosan that has been further processed to include these oppositely charged ionic groups.

Selection of the oppositely charged ionic groups being used in the biopolymer, if modified, e.g., modified chitosan, depends upon the desired properties and use for the plastic material, as well as which type of ionic groups are being used on the modified alginate. However, similar to modified alginate, in the modified biopolymer, the oppositely charged ionic group is one that generally has a relatively high degree of ionization in water over a relatively broad pH range. As noted above, in embodiments, the modified biopolymer comprises cationic groups (i.e., other than ammonium —NH₃⁺). An illustrative cationic group is a quaternary ammonium group —NR₃⁺. The “—” represents the linkage to a monosaccharide unit of the polysaccharide chain and each R is independently selected from alkyl groups and aryl groups. This includes linear alkyl groups having various numbers of carbon atoms, e.g., 1, 2, 3, 4, etc. The chemical structure of this linkage depends upon the process used to modify the chitosan. In embodiments, the cationic group may be represented by the formula —NHCH₂CH(OH)CH₂NR₃⁺, wherein R has been defined above. In this formula, the “—” represents the covalent bond between the carbon atom of the cationic group and a carbon atom of the monosaccharide unit of the polysaccharide chain. In embodiments, the anionic group has the formula —NHCH₂CH(OH)CH₂N(CH₃)₃⁺. (See FIG. 1B, right image.) Chitosan modified with quaternary ammonium groups (regardless of the specific type of quaternary ammonium group and the specific type of linkage) may be referred to herein as quaternized chitosan.

The Example below describes a method that may be used to provide quaternized chitosan. The modified chitosan may be synthesized with a desired degree of substitution, depending upon the desired properties and use for the plastic material. In embodiments, the degree of substitution is relatively high, including at least 50%, at least 55%, at least 60%, at least 65%, at least 70%, at least 80%, at least 90%, 100%, or a range between any of these values.

The present plastic materials may comprise the modified alginate and the biopolymer in various weight ratios, depending upon the desired properties and use thereof. However, in embodiments, the weight ratio is that which provides a charge stoichiometry ratio of about 1 between the ionic groups of the modified alginate and the oppositely charged ionic groups of the biopolymer. In embodiments, about equal amounts of each are used such that the weight ratio of the modified alginate and the biopolymer is about 1.

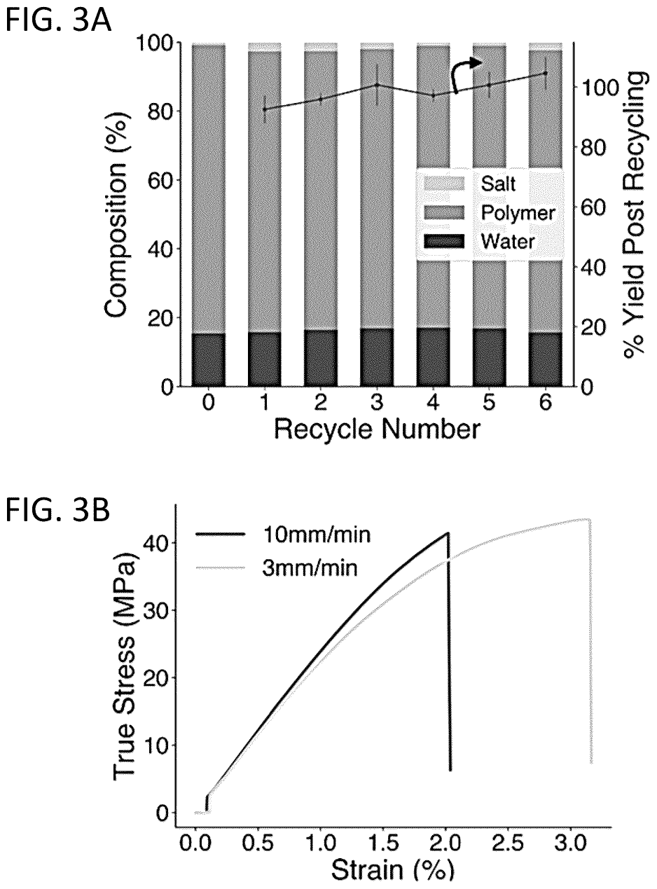

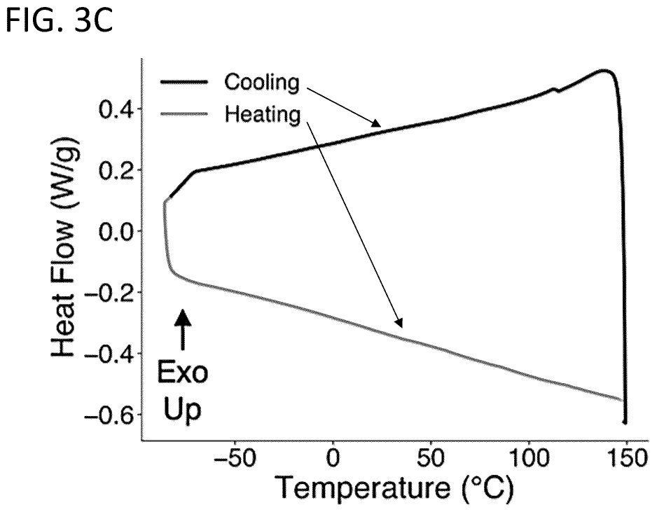

The primary component of the present plastic materials is the solid polyelectrolyte complex and like this complex, the plastic material is also a solid. (See FIG. 3A.) By “primary” it is meant that a majority of the weight of the plastic material is from the solid polyelectrolyte complex. This includes the solid polyelectrolyte complex being present in the plastic material at an amount of at least 75 weight %, at least 80 weight %, at least 85 weight %, at least 90 weight %, or a range of between any of these values. (Weight % refers to (weight of the solid polyelectrolyte complex)/(weight of the plastic material)*100.) Water, which has a plasticizing effect, may also be present in the plastic material. However, in embodiments, the amount of water is no more than 25 weight %, no more than 20 weight %, no more than 15% weight %, no more than 10 weight %, or a range of between any of these values. (Weight % refers to (weight of the water)/(weight of the plastic material)*100.) In embodiments, the plastic material consists of the solid polyelectrolyte complex and optionally, water. (This doesn't preclude the presence of a minor amount of salt ions in the plastic material, e.g., Na⁺, Cl⁻.) However, other components may be included in the plastic material as desired in various amounts, e.g., crosslinkers, plasticizers, surfactants, dyes, fillers, etc. Regarding plasticizers, the modified alginate, the biopolymer, or both may be additionally modified to include functional groups having a plasticizing effect, e.g., dimethyl aminomalonate. To improve barrier properties, coatings may be included on surfaces of the plastic material, e.g., parylene C.

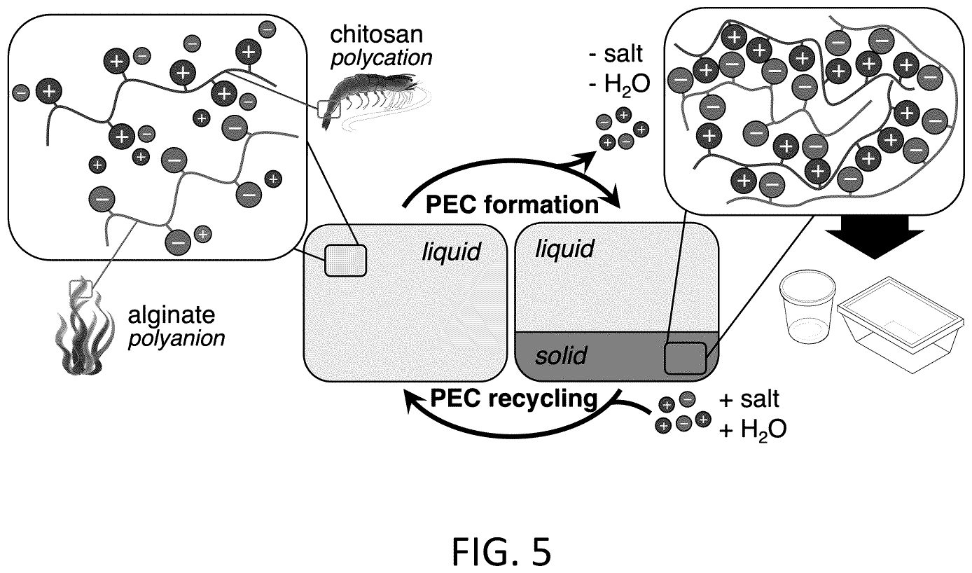

The present plastic materials may be characterized by their morphology, selection of which depends upon the desired use thereof. As demonstrated in the Example, below, the primary component of the plastic material, the solid polyelectrolyte complex, is amenable to a variety of industrially relevant plastic processing techniques, e.g., compression molding, extrusion molding, injection molding, etc. These processing techniques may be used to shape the solid polyelectrolyte complex into a plastic material having various morphologies, e.g., sheets, films, bags, containers, bottles, caps, etc. (See FIGS. 1D, 2C, 2D, 5.) Applications for the plastic materials include those in which plastic materials are generally used, including packaging in the food industry.

The present plastic materials may be characterized by various properties as described in the Example, below. This includes having mechanical properties, e.g., elastic moduli, similar to those of synthetic polymers such as polyethylene. However, unlike such synthetic polymers, the present plastic materials are both recyclable and biodegradable.

Regarding recyclability, this may be accomplished by exposing the plastic material to water in the presence of a salt of a type and amount sufficient to dissolve the solid polyelectrolyte complex of the plastic material. The salt disrupts the electrostatic attraction between the ionic groups of the modified alginate and the oppositely charged ionic groups of the biopolymer, allowing the individual biopolymers of the solid polyelectrolyte complex to dissolve in the salt solution. The specific salt, its amount, and exposure conditions depend upon the particular solid polyelectrolyte complex. However, as demonstrated in the Example, below, exposing the plastic material composed of the solid polyelectrolyte complex of FIG. 1D to 0.6 M NaCl for a few hours is sufficient. This salinity is similar to that of ocean water. The plastic material may be regenerated by removing salt (e.g., by diluting with water to decrease salt concentration) to facilitate reassociation of the ionic groups of the modified alginate and the oppositely charged ionic groups of the biopolymer to reform the solid polyelectrolyte complex. The solid polyelectrolyte complex may be subjected to further processing as described above to achieve any desired morphology. The Example, below, also shows that the plastic material may be recycled multiple times using these steps with full recovery of its properties.

Regarding biodegradability, this may be accomplished by exposing the plastic material to enzymes capable of decomposing chemical bonds within the modified alginate and the biopolymer. Prior to exposure, the plastic material may be exposed to a salt solution as described above to dissolve the solid polyelectrolyte complex. Alginate lyase is a marine enzyme that may be used to decompose the modified alginate. Cellulase and chitosanase are enzymes that may be used to decompose chitosan, including modified chitosan. These enzymes may also be present in ocean water.

The methods of forming the plastic material, recycling the plastic material, decomposing the plastic material described above are also encompassed by the present disclosure.

### Example

### Introduction

In this Example, the polysaccharides alginate and chitosan were chemically modified and then combined form a solid polyelectrolyte complex (PEC) material possessing both recyclability and biodegradability. The material can be processed with industrially relevant methods into a transparent, glassy film with the mechanical strength required for many single-use packaging applications and retain on average 98% of the material after recycling. This biopolymer-based plastic alternative fulfills many sustainability considerations. Processing and forming the PEC film requires little energy as the PEC self-assembles, unlike traditional plastics that require a high temperature-facilitated method. Carbon usage is also relatively low as the polysaccharides derive from naturally abundant sources. Lastly, these materials retain their mechanical strength even after several recycles and readily dissolve at ocean salinity, demonstrating sustainability through plastic circularity and ocean plastic mitigation.

### Experimental

### Materials

Sodium alginate (#W201502), MES hydrate (#M2933), amino-propanesulfonic acid (#A76109), sterile filters (#Z370606-1CS), glycidyltrimethylammonium chloride (#50053), diafiltration units (#UFC9010), alginate lyase (#A1603), cellulase (#ICN15058305), chitosanase (#C9830), deuterium oxide (#1133660009), Milli-Q water, silver nitrate (#209139), deuterium chloride solution (#543047), hydrochloric acid (#320331), sodium hydroxide (#567530), and acetic acid (#8.18755) were all purchased from Sigma Aldrich (St. Louis, MO). Sodium chloride (#S271-1), N-hydroxysuccinimide (NHS, #24500), 1-ethyl-3-(3-dimethylaminopropyl) carbodiimide hydrochloride (EDC, #22980), and dialysis tubing (#0867014C) were purchased from Fisher Scientific (Waltham, MA). Chitosan (#YC158299) was purchased from Biosynth (United Kingdom). Kapton film (#FN1) was purchased from American DU-RAFILM (Holliston, MA). Polyacrylamide gels (#4561094), 2× Laemmli Buffer (#1610737), 10× Tris/Glycine/SDS Buffer (#1610732), and Coomassie Stain (#1610786) were purchased from Bio-Rad (Hercules, California).

### Methods

### Synthesis of Alginate-Sulfonic Acid

Sodium alginate was dissolved at 10 wt % in MES buffer pH 4.5 (0.2 M MES hydrate, 0.15 M NaCl) before the sequential addition of NHS (5 eq), EDC (5 eq), and amino-propanesulfonic acid (10 eq). The pH was adjusted if necessary to 6.5, and the solution was stirred at room temperature for 24 hours. The solution was then dialyzed (MWCO 3.5 kD) against Milli-Q water 3×3 days before being sterile filtered and lyophilized (Labconco) for 3 days until dry fluffy product formed. Successful addition of the sulfonic acid was confirmed via ¹H NMR spectroscopy performed on a 10 mg/mL solution of alginate-sulfonic acid in deuterium oxide at 25° C. with a Bruker Avance III HD nanobay 400 MHz (data not shown). The peaks used for analyzing the degree of substitution were the signal from the 5 backbone protons and the peaks of 4 of the protons on the hydrocarbon linker to the sulfate (data not shown).

### Synthesis of Quaternized Chitosan

The degree of deacetylation of the commercially purchased chitosan was found using ¹H NMR on chitosan dissolved in D₂O with enough DCl added to dissolve the chitosan at 10 mg/mL.

The methyl protons on the acetyl group (δ=2.0 ppm) were chosen for the analysis and compared to the protons around the sugar ring. The analyzed spectrum revealed a degree of deacetylation of 88.5%. Next, chitosan was quaternized. Briefly, chitosan (0.5 g) was suspended in Milli-Q water (38 mL) before acetic acid was added to a final concentration of 0.5% v/v. This solution was stirred for 24 hours at room temperature before the addition of glycidyltrimethylammonium chloride (GTMAC, 8 eq) over 3 equal volume increments spaced 2 hours apart. It was found to be critical to delay heating until all the GTMAC is added. Thus, only after all reagents were added, the reaction mixture was heated to 55° C. and stirred for 18 hours. The reaction time was also found to be critical as GTMAC can degrade over time, causing unexpected reaction products. The solution was then diluted with 100 mL Milli-Q water, adjusting the pH to 7 if necessary before purifying the product via diafiltration until the filtrate conductance<10 μS. The product was lyophilized over 3 days until dry puffy solid formed. Successful quaternization of the chitosan was confirmed via FTIR spectroscopy performed on solid quaternized chitosan with a Perkin Elmer Spectrum Two FT-IR Spectrometer (data not shown). Quaternization of the chitosan was quantitatively determined using ¹H NMR spectroscopy performed on a 10 mg/mL solution of quaternized chitosan in deuterium oxide at 25° C. with a Bruker Avance III HD nanobay 400 MHz (data not shown). Comparison of the peaks corresponding to the sugar backbone protons with the methyl protons led to a degree of deacetylation 89.6%, which is on par with the value previously found (data not shown). So, the sugar backbone protons were chosen for comparison to the protons on the quaternary ammonium (6=3.16 ppm) to determine the degree of substitution.

### Conductance Titration Measurements

Titration of quaternized chitosan with silver nitrate (AgNO₃) was performed. Briefly, 0.1 g of quaternized chitosan was dissolved in 100 mL of Milli-Q water. Conductance was measured using a Traceable Conductivity Meter (#UX-19601-03) as 0.017 M AgNO₃ solution in Milli-Q water was added to the chitosan solution in increments of 0.5 mL. The volume of AgNO₃ added that resulted in the lowest conductance of the solution was employed to find the degree of substitution with Equation 1. (See Cho, J., et al., Biomacromolecules 2006, 7, 2845-2855.)

### Gel Permeation Chromatography

Gel permeation chromatography (GPC) was performed on a 2 mg/mL solution of alginate in 1×PBS in a Tosoh EcoSEC. All solutions were passed through 0.2 μm PTFE filters. GPC was performed with a 0.3 mL/min flow rate, 30 minute run time, dn/dc of 0.15 mL/g, and injection volume of 35 μL. Molecular weight analysis was done using PEG standards to create the calibration curve.

### Formation of Polyelectrolyte Mixtures

Liquid coacervates were formed by mixing equal volumes of sodium alginate solution (4 wt % in Milli-Q water, pH adjusted to 7) and chitosan solution (4 wt % in 1% acetic acid), shaking vigorously, and then centrifuging at 4000×g for 20 min. Solid polyelectrolyte complexes were formed by mixing equal volumes of alginate-sulfonic acid solution (4 wt % in Milli-Q water, pH adjusted to 7) and quaternized chitosan solution (4 wt % in Milli-Q water, pH adjusted to 7), shaking vigorously, and then centrifuging at 4000×g for 20 min. The 4 wt % was chosen to achieve (1) an estimated charge stoichiometry ratio of 1 between oppositely charged groups on the biopolymers and (2) efficient polymer-rich phase formation by using the highest polymer concentration soluble in the solvent. Charge density was found using the equation ρ_{c}=cNf/M_{w}, where ρ_{c} is the charge density in mmol/mL, c is the concentration in g/mL, N is the degree of polymerization, f is the degree of substitution of the charged groups, and M_{w} is the average molecular weight of the polymer.

### Polyelectrolyte Complex (PEC) Film Formation

The solid formed after mixing alginate-sulfonic acid solution and quaternized chitosan solution together was separated from the supernatant and put between two sheets of Kapton film and placed in a Carver melt press heated to 50° C. for 5 minutes without pressure and then 5 minutes with a pressure of approximately 9 psi. Metal spacers of varying thicknesses were used to achieve different film thicknesses. The PEC film was removed from the Kapton film and left at room temperature for 24 hours to dry (ambient conditions were around 60% RH).

### Recycling of PEC Films

Pieces of PEC film were placed in 0.6 M NaCl at a ratio of 15 mg material to 1 mL solution and allowed to dissolve for 3 hours before adding Milli-Q water to a final NaCl concentration of 0.1 M. The solution was shaken and then centrifuged at 4000×g for 20 min before the supernatant was poured off and replaced by fresh Milli-Q water and centrifuged again. The supernatant was replaced one more time and centrifuged before separating the solid phase and re-pressing into a new PEC film. The following equation was used to determine recycling efficiency:

$$\% Mass Yielded Post Recycling = \frac{Mass of PEC after recycling}{Mass of PEC before recycling} \qquad ( 2 )$$

### Salt Resistance Test of PEC Films

1-2 mg pieces of PEC film were placed in 1.5 mL Eppendorf tubes and solutions of NaCl at varying concentrations were added at a ratio of 500 μL per 2 mg of solid. The mixture was left at room temperature for 24 hours to reach equilibrium level of dissolution before observations were made.

### ζPotential Measurements of Biopolymers

Alginate and alginate-sulfonic acid were dissolved in Milli-Q water at 1 mg/mL. The pH was characterized using a Thermo Scientific accumet XL500 Benchtop pH meter. The conductivity and ζpotential were measured using a Wyatt Mobius Dynamic Light Scattering instrument by loading 50 μL of each solution into a Mobius dip cell (Wyatt Technology) and measuring 5 replicates at 25° C. Both solutions were brought to neutral pH with HCl and NaOH and the same characterization as above was performed again. Chitosan and quaternized chitosan were dissolved in 0.5% v/v acetic acid at 1 mg/mL. The pH, conductivity, and ζpotential were measured for both these solutions and after these solutions were brought to neutral pH.

### Dynamic Mechanical Analysis (DMA) of PEC Films

Strips of PEC film were cut in rectangles such that the (length)/(width×thickness) ratio was 10 every time. These strips were placed in the clamps of the tension attachment of a TA Instruments RSA-G2 Dynamic Mechanical Analyzer with the axial force tension set to 0.25 N. After equilibration to 25° C., an amplitude sweep at 1 Hz frequency was done from 0.05% to 0.2% to determine the linear viscoelastic regime (data not shown) followed by a frequency sweep at 0.1% strain from 0.1 rad/s to 100 rad/s. Finally, a temperature sweep was performed at 1 Hz frequency and 0.1% strain from 25° C. to 100° C. Stress relaxation was measured using step strain measurements at a target strain of 0.35%, which was determined to be within the linear viscoelastic regime (data not shown).

### Thermogravimetric Analysis (TGA) of PEC Films

Composition of the PEC films was found by heating 4-8 mg of PEC film in a TA Instruments Discovery Thermogravimetric Analyzer under air conditions first to 110° C. for 1 hour before ramping the temperature at 10° C./min to 550° C. and then holding at 550° C. for 1 hour. Water was assumed to be gone from the sample after 1 hour at 110° C., and salt was assumed to be the only component left at the end.

### Differential Scanning Calorimetry (DSC) of PEC Films

A 5 mg piece of PEC film was placed in an Aluminum pan that was sealed and placed in a TA Instruments Discovery Differential Scanning Calorimeter 2500. The sample was heated to 150° C., cooled to −90° C., and heated to 150° C. at a rate of 10° C./min. The first temperature ramp up was discarded. A maximum temperature of 150° C. was chosen based on the degradation temperatures of the individual biopolymers (data not shown).

### Water Permeability Testing of PEC Films

PEC films were cut into circles the size of the outer diameter of a Moisture Permeability Cup (Gardco) and placed over the cup filled with 4 mL of Milli-Q water. A gasket was used to fully seal the chamber along with an outer ring that was screwed on top. The entire cup with water and film was placed on a microbalance at 20° C. and 60% RH, and the weight was periodically documented over 24 hours. This test procedure follows ASTM Method D1653 Test Method B (https://astm.org/d1653.html) for vapor permeability. The water vapor transmission rate (WVTR) was found taking the slope of a linear regression fit to the weight of water evaporated vs. time plot dM_{gas}/dt and dividing it by the area A of the film exposed to vapor (10 cm²).

### Alginate and Alginate-Sulfonic Acid Degradation Assay

100 μL of alginate lyase (1 mg/mL in Milli-Q water) was added to 1 mL of alginate or alginate-sulfonic acid (0.5 wt % in Milli-Q water) and incubated at 37° C. for 48 hours. All solutions were sterile filtered. Absorbance was measured from 200 nm to 600 nm using a Shimadzu UV-3600 Plus Spectrophotometer and Quartz Spectrophotometer Cell (Shimadzu).

For time lapse measurements, 100 μL of alginate lyase was added to 1 mL of alginate or alginate-sulfonic acid in the cuvette at 20° C. and absorbance over the same wavelength range was measured once every 30 seconds for 30 minutes.

### Quaternized Chitosan Degradation Test and Characterization

455 μL of quaternized chitosan (10 mg/mL in 0.2 M sodium acetate buffer pH 5.0) was mixed with 45 μL of either 2 mg/mL cellulase, 1 mg/mL chitosanase, or sodium acetate buffer as well as an additional 500 μL of buffer. The reaction mixtures were incubated at 37° C. for 2 hours before being boiled at 100° C. for 10 minutes. The samples were then centrifuged at 10,000×g for 10 minutes. 250 μL of each supernatant was mixed with 250 μL of 2× Laemmli buffer. 35 μL of this mixture was loaded into the wells of a 4-20% gradient polyacrylamide gel. The gel was run at 80V for 90 minutes followed by 120V for 5 minutes in SDS running buffer (25 mM Tris base, 192 mM glycine, 0.1% SDS). After detachment from the cassette, the gel was washed with 200 mL of Milli-Q water for 10 minutes before being stained with Coomassie for 1 hour. Finally, the gel was placed in water and imaged after 3 hours.

### Results and Discussion

### Formation of Biopolymer-Based Plastic by Solid Polyelectrolyte Complexation

The combination of two oppositely charged polymers, or polyelectrolytes, at certain low salt conditions will lead to phase separation into two phases: a polymer-rich phase and a salt-rich phase. The polymer-rich phase state can either be liquid or solid depending on a variety of factors including the polyelectrolyte strength, where strong polyelectrolytes exhibit degrees of ionization largely independent of pH. Liquid-liquid phase separation is often seen in weaker polyelectrolytes or in non-polymer charged species that still benefit from the entropic gain of releasing salt ions, whereas strong polyelectrolytes often form a solid PEC separated from the liquid supernatant. The carboxylic acid of alginate and the amine of chitosan have pKa values of around 3.5 and 6.5, respectively, so the solution pH is critical to fully ionizing their charged groups (FIGS. 1A and 1B, left images). Mixing these unmodified biopolymers results in a liquid coacervate phase. After the water is evaporated from this liquid, the low polymer density leads to a lack of substantial mechanical strength, creating a brittle, paper tissue-like material (FIG. 1C).

Thus, the charged groups of alginate and chitosan were chemically modified to drive the phase of the self-assembled biopolymers to the solid state, where the polymer density is higher. Carboxylic acids exhibit weaker associations with oppositely charged polyelectrolytes compared to sulfonates. To enhance the interaction strength of alginate, the carboxylic acid of alginate was substituted with a sulfonic acid. (FIG. 1A, right image). Although primary amines on synthetic polyelectrolytes exhibit stronger interactions than quaternary ammoniums, the amine of chitosan was substituted with a quaternized ammonium because of its pH-independent ionization and thus enhanced solubility of chitosan in non-acidic solvents. (FIG. 1B, right image).

Alginate-sulfonic acid was synthesized using an EDC/NHS coupling reaction (FIG. 1A). The degree of substitution (DS) of the carboxylic acids with sulfonic acid was determined using NMR and found to be 83.1% (Table 1, other data not shown). To synthesize the quaternized chitosan, the amines on the deacetylated groups were targeted, which was determined via NMR and Equation 1 to be 88.5% of the monomers (data not shown). Successful addition of the quaternary ammonium was verified with FTIR (data not shown), and the final DS of all monomers on chitosan was quantitatively found to be 70.1% via NMR (Table 1, other data not shown), which was close to the 65.8% found using conductivity measurements during titration of a quaternized chitosan solution with AgNO₃ (data not shown).

TABLE 1
Molecular Weight (M_{w}), Degree of Polymerization (DP), Degree
of Substitution (DS), and Charge Density in a 4 wt % Solution
of Modified Biopolymers Alginate-Sulfonic Acid (AlgS) and
Quaternized Chitosan (qCHI) Obtained from GPC and NMR.

| | Mw | | | rₑ |
|---|---|---|---|---|
| Polymer | (g/mol) | DP | DS | (mmol e/mL) |
| AlgS | 146,983 | 206 | 83.1 | 0.17 |
| qCHI | 200,000 | 1206 | 70.1 | 0.17 |

To form the biopolymer-based PEC, equal volumes of a 4 wt % solution of alginate-sulfonic acid and a 4 wt % solution of quaternized chitosan were combined, which corresponds to a charge stoichiometric ratio of 1 (Table 1). The resulting solid PEC could be pressed into a thin, transparent film (FIG. 1D) with substantially higher density than the material made from unmodified alginate and chitosan (FIG. 1C).

### Biopolymer-Based PEC Material is Industrially Processable and Fully Recyclable Via Addition of Salt

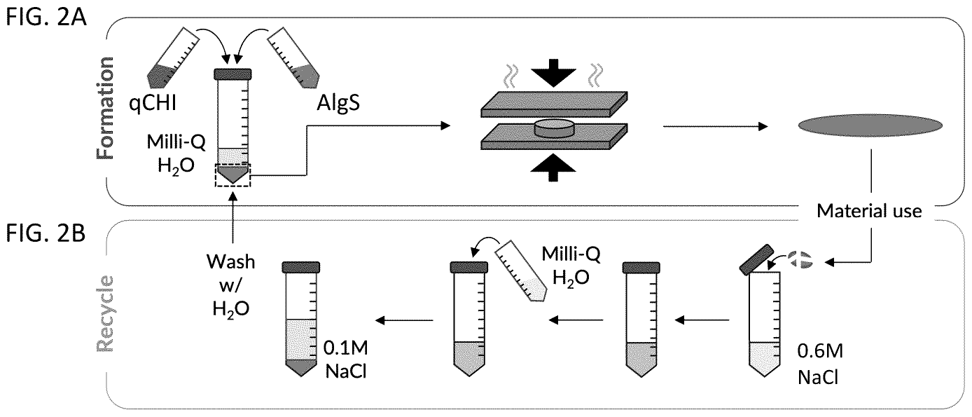

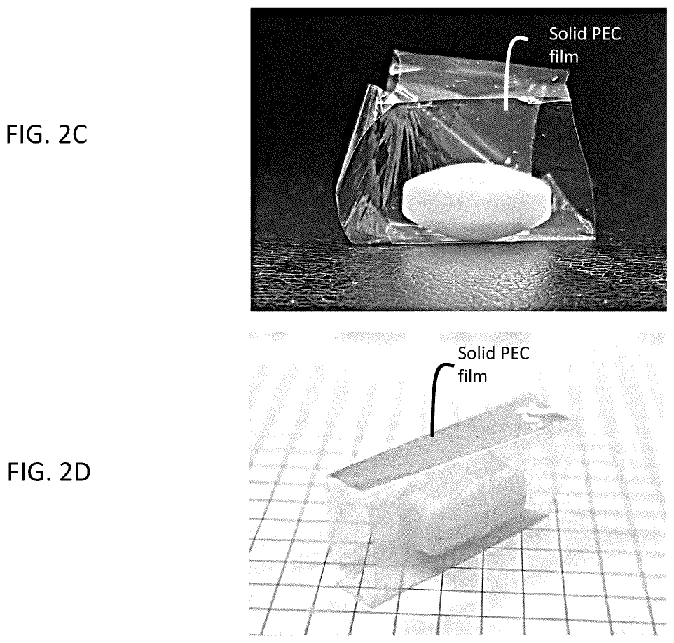

When developing new plastic alternatives, it is crucial to consider how to use existing manufacturing processes to produce the materials to facilitate technology adoption. Commercial plastics are largely processed through methods such as blow molding, injection molding, and compression molding. Thus, a melt press was used to form thin films from biopolymer-based PECs to show that they could be processed with existing equipment. After the phase separation occurred, the solid phase was separated from the supernatant along with the entrained water in this phase. This rubbery substance was placed between two metal plates heated to a temperature of 50° C. and compressed at a pressure of approximately 9 psi (FIG. 2A). The material was then allowed to completely cool and dry. The thickness of the transparent film produced supports packaging applications such as single-use wrappers for small objects or candies (FIG. 2C).

Recycling the biopolymer-based PEC requires increasing the salt concentration to destabilize the ionic bonds between polyelectrolytes. Salt resistance of PECs scales with several different parameters, including higher charge density, increased blockiness, lower polarity or higher hydrophobicity, and higher polyelectrolyte chain length. For the alginate-sulfonic acid and the quaternized chitosan PEC, a concentration of 0.6 M NaCl was required to completely dissolve the PEC into solution with no viscous, polymer-rich phase remaining (images not shown). Thus, the choice to recycle the materials at 0.6 M NaCl is based closely on the salt resistance of the PEC and the desire to minimize the water needed to dilute the salt when reforming the solid PEC phase. To recycle, pieces of the biopolymer-based PEC were placed into a solution of 0.6 M NaCl (FIG. 2B). Once the now homogeneous solution reached equilibrium, the salt content was decreased by diluting the solution with deionized water to a concentration of 0.1 M NaCl. At this concentration of salt, a new solid PEC formed, and after washing with deionized water to remove any residual salt, the solid PEC was then reprocessed into a new piece of plastic film (FIG. 2B). Notably, the recycled material still maintained a transparent appearance and could be reused as new packaging material (FIG. 2D).

### Thermal, Chemical, and Physical Properties of the Biopolymer-Based PECs are Maintained Across Multiple Recycles

Critical to packaging applications is the mechanical strength of the materials, so dynamic mechanical analysis (DMA) was used to quantify the modulus of the biopolymer-based PEC films. As expected for a solid film, the elastic modulus (G′) and viscous modulus (G″) were constant over the frequency range measured with G′ greater than G″ (data not shown). The G′ value of approximately 1.5 GPa at 1 Hz frequency is on par with thin polyethylene-based films, such as ultra high molecular weight polyethylene (UHMWPE), high density polyethylene (HDPE), and low density polyethylene (LDPE) that have elastic moduli measured at 0.95 GPa, 1.6 GPa, and 0.67 GPa, respectively. These PEC films contain entanglements and non-covalent ionic associations that give rise to the viscoelastic behavior observed, including stress relaxation (data not shown). The elastic and viscous moduli of the PEC films were maintained across at least six full recycles of the same piece. Though the biopolymer-based PEC materials possess stiffness comparable to commercial plastics like LDPE, they were not very ductile, breaking at 2% and 3% strain depending on the testing speed (FIG. 3B).

Thermogravimetric analysis (TGA) measurements showed that the composition of the PEC films across multiple recycles remained mostly consistent though the films retained between 10 wt % and 20 wt % water (FIG. 3A). An increase in the modulus value was observed after Recycle 2 from −1 GPa to −2.5 GPa (data not shown) before the moduli values for later recycles returned to the material's initial range. It was hypothesized that the increased modulus was due to decreased water content. TGA revealed that the water content in Recycle 1 (˜1 GPa) was 13.7% while the water content in Recycle 2 (˜2.5 GPa) was 9.7%. Increased water content enhances the free volume in PECs, which can facilitate polymer chain motion and decrease resistance as chains slide. Additionally, water contributes to PEC mechanical behavior most substantially by disrupting ionic bonds between the polyelectrolytes. Many PECs exhibit an inverse relationship between number of water molecules and T_{g}. Overall, increased water content leads to a lower T_{g}, which is associated with improved processability as well as a decrease in PEC modulus.

Given the amount of water retained in the PEC films, it was hypothesized that the mechanical behavior could be affected by heating these films up to 100° C. It was found that while there was a slight decrease as temperature increased, the elastic modulus remained around 1 GPa, consistent with stress-strain data within the same range of temperatures on poly(methacrylic acid) and poly(trimethyl aminoethyl methacrylate) PECs. This only slight change in material behavior was also seen in the tangent delta, which showed no thermal transitions (data not shown). Additional characterization using differential scanning calorimetry (DSC) on these materials did not reveal any peaks associated with thermal transitions (FIG. 3C), suggesting a T_{g} for the PEC films of greater than 150° C. This is consistent with the fact that dry or low hydration PECs often have indiscernible or no T_{g}.

Besides the consistency in composition, these materials also exhibited high recycling efficiency (evaluated using Equation 2) across multiple recycles of different PEC pieces (FIG. 3A). Across 6 recycles, an average of 98% of the original mass recycled was obtained after the recycling process. In some recycles, it was found that the recycling yield even exceeded 100%. This can occur due to the addition of salt and water during the recycling process, both of which may not be entirely extracted to the same degree when reforming the solid PEC. It was observed that for recycled PECs where the salt content was lower (˜1-2% in Recycle 4), the recycling efficiency was closer to 95%, whereas the recycled PECs with higher salt content (˜3% in Recycle 6) yielded more mass after recycling (FIG. 3A). While the recycled PECs were washed with pure water after formation, it is possible that a longer submersion in pure water could result in more compositionally consistent PECs.

### Exposure of Biopolymer-Based PECs to Moisture

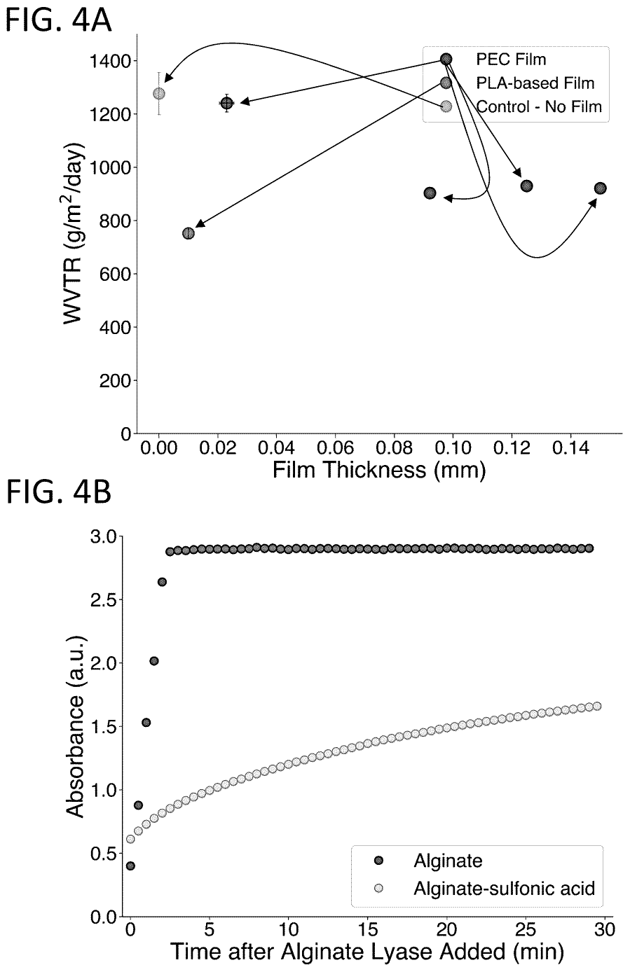

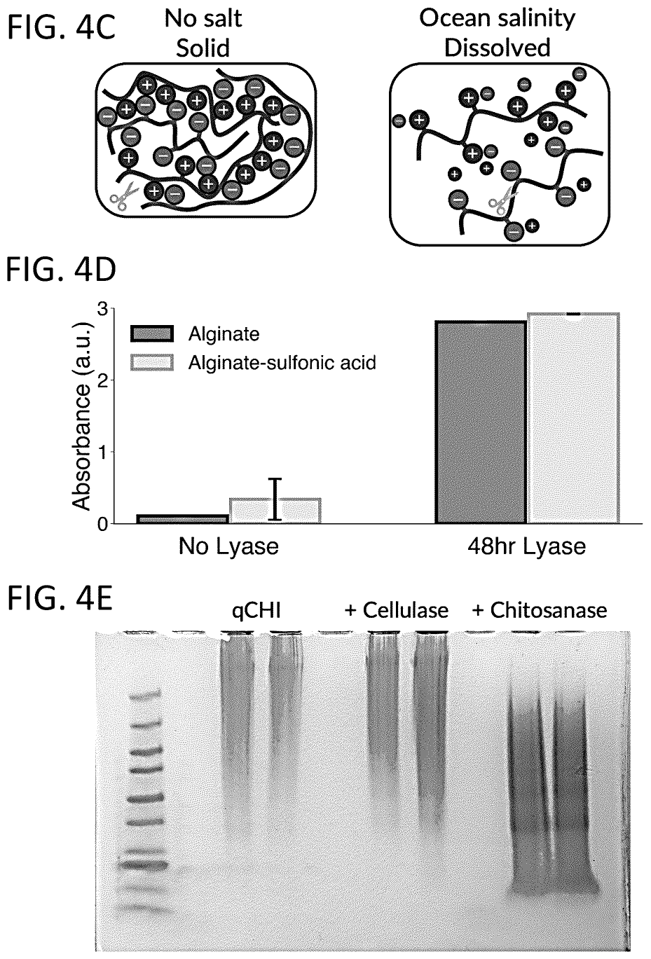

It was hypothesized that the hydrophilic nature of the polysaccharides and susceptibility of PECs to water could lead to poor water barrier properties. Water vapor transmission rate (WVTR) was measured following ASTM D1653 and exhibited two regimes: below a film thickness of 0.04 mm, the film offers no barrier, while above that thickness, WVTR decreases to 903 g/m²/day (FIG. 4A). The appearance of two distinct regimes was surprising as it was assumed that water vapor diffuses through a material with a linear dependence on material thickness. However, it was hypothesized that the observation seen here is due to inhomogeneities in the thin film. These inhomogeneities in the material could produce areas of more porous material, particularly as the film gets thinner. One potential source of inhomogeneity is the biopolymer polydispersity, which for the commercially purchased alginate was found to be 2.74 (data not shown). WVTR in polyethylene films showed greater variability in the water permeability coefficient in thinner films when the polymers exhibited wider molecular environments but past a certain thickness, that permeability aligned with films made from monodisperse distributions. Another possibility is incomplete crosslinking between charged groups. Because the polyelectrolytes phase separate upon complexation, the initial ionic bonds that form are maintained, which can lead to patches in the dried structure.

Moisture barrier properties play a large role in understanding the use case for a material. While packaging for fresh fruit and vegetables might benefit from allowing gas exchange and water vapor permeability, that same packaging would be unsuitable for foods meant to be shelf-stable for months. There are no specific rating scales to classify barrier grades, but according to general guidance, 903 g/m²/day is useful for materials such as bakery products and fresh fruits or salads. In addition, the present biopolymer-based PEC material performs better than the WVTR recorded at 1146 g/m²/day for pure chitosan films under similar conditions.

Despite superior moisture blocking, many plastic packaging materials exhibit insufficient oxygen barrier properties, which limits their use as perishable packaging. A common strategy is to apply coatings that block oxygen gas diffusion. In fact, synthetic PEC-based coatings, such as polyethylenimine and polyacrylic acid, on the plastic poly(ethylene terephthalate) (PET) as well as paper have been shown to greatly reduce their oxygen transmission rates. Thus, the moisture barrier of the present biopolymer-based PEC materials may be improved by coating it with a biocompatible paraylene C coating that still maintains the material sustainability. This strategy would also work well for packaging salty foods to avoid softening the PEC material and threatening the material's structural integrity.

Finally, another concern for packaging materials is their performance indifferent humidity environments (i.e. the packaging materials have to perform in both the tropics as well as in drier climates). In pure deionized water, the PEC films slightly swell and soften but do not dissolve or disintegrate. After incubation in a chamber with 80% relative humidity (RH) and 20° C. for 24 hours, the elastic modulus of the PEC films dropped to values of as low as 0.5 GPa at 1 Hz (data not shown). This modulus value is less than one order of magnitude below the average value of 1 GPa at ambient humidity of 60% RH, suggesting that, even in tropical locations with elevated humidity, the materials will exhibit consistent physical behavior. This is in contrast to pure alginate and chitosan fibers, which dropped one order of magnitude in modulus from 50% RH to 90% RH at 25° C. Pure alginate and chitosan fibers exhibited an elastic modulus at 50% RH of as high as 6 GPa, which could be due to using higher molecular weight biopolymers.

### Environmental Impact of Biopolymer-Based PECs

Ocean plastic has led to the formation of “plastic islands,” which may significantly contribute to ocean microplastic pollution. The sensitivity of PEC dissolution to salinity mitigates material accumulation in the ocean. The salt concentration needed for these PECs to fully dissolve, 0.6 M NaCl, is equivalent to the ocean's 3.5 wt % salinity. While oceans contain more ions than sodium and chloride, they are the most abundant at 90%, suggesting that PEC films will dissolve in ocean water and prevent further plastic buildup.

Besides dissolving the PEC material by increasing salt content, it is also crucial that these biopolymers are still biodegradable. These polysaccharides are food sources for many ocean microorganisms, which means a diverse set of enzymes can naturally degrade alginate and chitosan. By dissolving the PECs, the existing biodegradable linkages within alginate-sulfonic acid and quaternized chitosan become more available for attack by enzymes than when in their solid form (FIG. 4C), increasing their rate of degradation.

Thus, the degradation of alginate and alginate-sulfonic acid by alginate lyase, a common marine enzyme, was compared. The degradation was detected using absorbance at 235 nm, which corresponds to the double bond formed when the ether bond covalently linking two alginate monomers together is broken via a β-elimination mechanism. The initial 30 minutes of the reaction appears to occur at different rates for alginate compared to alginate-sulfonic acid, suggesting that the sulfonic acid modification could be slowing enzymatic activity (FIG. 4B). However, after a 48 hour period, the absorbance measured was the same for both alginate and alginate-sulfonic acid, indicating that the sulfonic acid modification did not change the final degree of degradation (FIG. 4D). This further supports the biodegradability of the present biopolymer-based PEC materials.

For the quaternized chitosan, biodegradation by cellulase and chitosanase, an enzyme secreted by several species including Streptomyces griseus, was evaluated. Using a polyacrylamide gel to characterize the molecular weight of the quaternized chitosan incubated with the enzymes, it was found that the chemical modification of chitosan did not inhibit enzyme activity. The quaternized chitosan was able to be digested by chitosanase from a molecular weight of around 200 kDa to molecular weights of 50 kDa, 30 kDa, and ˜13 kDa (FIG. 4E, data not shown). Chitosanase appeared to efficiently break down chitosan, which only showed a faint smudge at the lowest molecular weight positions of the gel (data not shown). Similar to alginate-sulfonic acid, quaternized chitosan is degraded by chitosanase at a slower rate than chitosan is. Cellulase did not seem to degrade either the quaternized chitosan or unmodified chitosan (data not shown).

### CONCLUSIONS

This Example presents a new sustainable alternative to conventional plastic for single-use packaging. The material is composed of alginate-sulfonic acid and quaternized chitosan, biopolymers derived from abundantly available and naturally occurring biowaste sources that undergo chemical modifications to become strong polyelectrolytes. These modified biopolymers undergo solid polyelectrolyte complexation, creating a material that is processable using industrial methods and recyclable via the addition of salt. The recycling process of disassembling the PEC via salt screening of the polyelectrolytes leaves the polymer chains intact, allowing the recycled material to still exhibit the same mechanical behavior as the pre-recycled PEC. Furthermore, the chemical modification of the biopolymers does not change their biodegradability by naturally secreted enzymes.

Additional information relating to this Example may be found in U.S. Provisional Patent Application No. 63/673,328 filed on Jul. 19, 2024, the entire disclosure of which is incorporated by reference herein.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the disclosure has been presented for purposes of illustration and of description. It is not intended to be exhaustive or to limit the disclosure to the precise form disclosed, and modifications and variations are possible in light of the above teachings or may be acquired from practice of the disclosure. The embodiments were chosen and described in order to explain the principles of the disclosure and as practical applications of the disclosure to enable one skilled in the art to utilize the disclosure in various embodiments and with various modifications as suited to the particular use contemplated. It is intended that the scope of the disclosure be defined by the claims appended hereto and their equivalents.

If not already included, all numeric values of parameters in the present disclosure are proceeded by the term “about” which means approximately. This encompasses those variations inherent to the measurement of the relevant parameter as understood by those of ordinary skill in the art. This also encompasses the exact value of the disclosed numeric value and values that round to the disclosed numeric value.

Unless otherwise indicated, and in recognition of the inherent nature of the techniques described herein, throughout the present disclosure, terms and phrases such as “absence,” “free,” “does not comprise,” etc. encompass, but do not require a perfect absence of the referenced entity.

Unless otherwise indicated, the term “type” as used herein refers to chemical formula such that a single type means the same chemical formula and different type means different chemical formula. Similarly, use of “more” as in “one or more types” refers to use of different types of the relevant entity.

Unless otherwise indicated, throughout the present disclosure, terms such as “comprising” and the like may be replaced with terms such as “consisting” and the like.

What is claimed is:

1. A plastic material comprising a solid polyelectrolyte complex formed between modified alginate comprising ionic groups other than carboxylate groups and a biopolymer comprising oppositely charged ionic groups.

2. The plastic material of claim 1, wherein the modified alginate comprises sulfonate groups, phosphate groups, or a combination thereof.

3. The plastic material of claim 1, wherein the modified alginate comprises sulfonate groups selected from formula —C(O)NH(CH₂)ₙSO₃⁻, wherein n is from 1 to 6.

4. The plastic material of claim 3, wherein the sulfonate groups have formula —C(O)NH(CH₂)₃SO₃⁻.

5. The plastic material of claim 1, wherein the modified alginate has a degree of substitution of at least 70%.

6. The plastic material of claim 1, wherein the biopolymer is chitosan.

7. The plastic material of claim 6, wherein the chitosan is modified chitosan.

8. The plastic material of claim 7, wherein the modified chitosan comprises quaternary ammonium groups.

9. The plastic material of claim 8, wherein the modified chitosan has a degree of substitution of at least 50%.

10. The plastic material of claim 1, comprising at least 75 weight % of the solid polyelectrolyte complex and no more than 25 weight % water.

11. The plastic material of claim 1, wherein the plastic material is configured as a food packaging material.

12. The plastic material of claim 1, wherein the modified alginate and the biopolymer are present at a weight ratio that provides a charge stoichiometry ratio of about 1 between the ionic groups of the modified alginate and the oppositely charged ionic groups of the biopolymer.

13. The plastic material of claim 1, wherein the modified alginate comprises sulfonate groups, phosphate groups, or a combination thereof, and the biopolymer is modified chitosan comprising quaternary ammonium groups.

14. The plastic material of claim 13, wherein the modified alginate comprises sulfonate groups selected from formula —C(O)NH(CH₂)ₙSO₃⁻, wherein n is from 1 to 6.

15. The plastic material of claim 14, wherein the modified alginate has a degree of substitution of at least 70% and the modified chitosan has a degree of substitution of at least 50%.

16. The plastic material of claim 15, wherein the modified alginate and the modified chitosan are present at a weight ratio that provides a charge stoichiometry ratio of about 1 between the ionic groups of the modified alginate and the oppositely charged ionic groups of the modified chitosan, and further wherein the plastic material comprises at least 75 weight % of the solid polyelectrolyte complex and no more than 25 weight % water.

17. A method of forming the plastic material of claim 1, the method comprising:
(a) exposing the modified alginate and the biopolymer to water under conditions sufficient to induce electrostatic association between the ionic groups of the modified alginate and the oppositely charged ionic groups of the biopolymer to form the solid polyelectrolyte complex; and
(b) subjecting the solid polyelectrolyte complex to a plastic processing technique to shape the solid polyelectrolyte complex into the plastic material.

18. A method of recycling the plastic material of claim 1, the method comprising:
(a) exposing the plastic material to a salt solution under conditions to disrupt electrostatic association between the ionic groups of the modified alginate and the oppositely charged ionic groups of the biopolymer to dissolve the solid polyelectrolyte complex;
(b) adding water to the salt solution to induce electrostatic association between the ionic groups of the modified alginate and the oppositely charged ionic groups of the biopolymer to reform the solid polyelectrolyte complex; and
(c) subjecting the reformed solid polyelectrolyte complex to a plastic processing technique to shape the reformed solid polyelectrolyte complex.

19. A method of decomposing the plastic material of claim 1, the method comprising:
(a) exposing the plastic material to a salt solution under conditions to disrupt electrostatic association between the ionic groups of the modified alginate and the oppositely charged ionic groups of the biopolymer to dissolve the solid polyelectrolyte complex; and
(b) exposing the dissolved solid polyelectrolyte complex to an enzyme capable of decomposing alginate, an enzyme capable of decomposing the biopolymer, or both.
